(19) United States
(12) Patent Application Publication
(10) Pub. No.: US 2009/0031679 A1
(43) Pub. Date: Feb. 5, 2009

(54) Disposable saddle pad

(76) Inventor: Kirsten Braden, Palm Beach, FL (US)

Correspondence Address: MCKENNA LONG & ALDRIDGE LLP, 1900 K STREET, NW, WASHINGTON, DC, 20006, US

(21) Appl. No.: 11/882,046

(22) Filed: Jul. 30, 2007

(51) Int. Cl. B68B 3/00

(52) U.S. Cl. 54/66

(57) ABSTRACT

A disposable saddle pad that includes a wicking layer to wick moisture away from a horse's skin. The disposable saddle pad may also include an absorbent layer to absorb moisture and a barrier layer to inhibit the pad from absorbing moisture from the atmosphere.

### BACKGROUND

1. Field of Invention

The present invention relates to a saddle pad, and in particular to a disposable saddle pad that protects a horse's back when a saddle is used.

2. Description of Related Art

Traditional saddle pads for English riding are typically made of a cotton substance. They usually have several layers of material to provide cushioning. They can be quilted, or cross stitched to hold a batting product contained within the traditional saddle pad.

Traditional saddle pads for Western riding are typically Navajo style rough woven material made from cotton or wool. This traditional saddle pad is folded and placed under the saddle to perform a similar function as the English traditional saddle pad.

The shape of the traditional saddle pads vary depending on the shape of the saddle. There are a variety of different shaped saddles to complement the different styles of riding. For example, dressage riders use a saddle that enables much of their legs to stretch down and around the horse. Race jockeys use a much smaller saddle that holds them up and off the horse's back resulting in hardly any leg contact. These two riders would use different traditional saddle pads to meet their objectives. The size of the traditional saddle pads also varies according to the size of the horse or pony.

Horses have a very inefficient mass to body surface ratio. When a horse works under a saddle, the horse exerts a lot more than it would normally do if left alone in a field. Hence, horses sweat more during work under the saddle. A traditional saddle pad under the saddle will usually absorb some of the sweat.

The traditional saddle pad also absorbs the dirt and oils produced by the horse and its environment, and therefore becomes very dirty. The most popular color for traditional saddle pads is white, which is the hardest to keep clean. In fact, in many English riding competitions, it is the only color permitted for the traditional saddle pad. In some English riding disciplines such as Hunter Jumpers and Dressage, a rider can lose marks for unkempt appearance. In order to stay clean, a traditional saddle pad has to be washed after every ride. An unwashed traditional saddle pad quickly becomes aesthetically displeasing, smelly, germ ridden, stiff, and generally lose functionality. Therefore, to keep a traditional saddle pad in good shape, a rider uses a washing machine either on site or at home.

### SUMMARY

In many cases, a washing machine is not available, such as when a rider is at a showground, on a trail riding in the forest, or at a fox hunt. Furthermore, most horse barns are rudimentary buildings that do not have washing machines.

The problem with taking dirty traditional saddle pads home and washing them in a home washing machine is that the traditional saddle pads tend to leave residual horse hair and dirt in the machine. This may be subsequently picked up by the next load of washing, which may be clothes worn by members of the household.

Repeated washings eventually wear out the traditional saddle pads. They develop lumps and wrinkles that may cause rubs and sores on the horse's back.

Also, traditional saddle pads made of dense layers of cotton are not good wicking material. Thus the horse working under the saddle quickly becomes very sweaty. Sweat is naturally designed to meet with air and cool down the horse. There is no airflow under the traditional saddle pad. Thus the horse becomes increasingly sweaty and hot under the saddle. It is in this hot, sweaty area that the horse bears the bulk of the rider's weight. This is extremely uncomfortable for the horse. When a traditional saddle pad becomes wet from the sweat, it loses its cushioning and ability to absorb pressure points caused by the saddle and the rider's weight.

Accordingly, solutions that solve one or more problems described above would be highly desirable.

Additional features and advantages will be set forth in the description, drawings and claims which follow, and in part will be apparent from the description, or may be learned by practice of the invention.

The advantages may be achieved by a disposable saddle pad comprising a wicking layer.

The advantages may also be achieved by a disposable saddle pad comprising a barrier layer.

It is to be understood that both the foregoing general description and the following detailed description are exemplary and explanatory and shall not be construed as limiting the scope of the claims.

### BRIEF DESCRIPTION OF THE DRAWINGS

Various exemplary embodiments of the invention are described in detail with reference to the following figures in which:

FIG. 1 is a view of a horse with a traditional saddle, and a disposable saddle pad according to an embodiment of the invention;

FIG. 2 is a more detailed view of the disposable saddle pad;

FIG. 3 illustrates an exploded view of the layers of the disposable saddle pad of FIG. 2;

FIG. 4 illustrates an exploded view of the disposable saddle pad after moisture has been absorbed;

FIG. 5 illustrates an exemplary disposable saddle pad where the wicking material and gel granules are incorporated into a single layer according to another embodiment of the invention;

FIG. 6 illustrates an exemplary disposable saddle pad where the thickness of the pad varies according to another embodiment of the invention;

FIG. 7 illustrates an exemplary disposable saddle pad where the cover includes a quilted pattern according to another embodiment of the invention;

FIG. 8 is a cross-sectional view of the disposable saddle pad of FIG. 7;

FIG. 9 illustrates an exemplary disposable saddle pad including a single layer inhibiting the pad from absorbing moisture according to another embodiment of the invention; and

FIG. 10 illustrates an exemplary disposable saddle pad including a single layer of gauze material according to another embodiment of the invention.

### DETAILED DESCRIPTION OF EXEMPLARY EMBODIMENTS

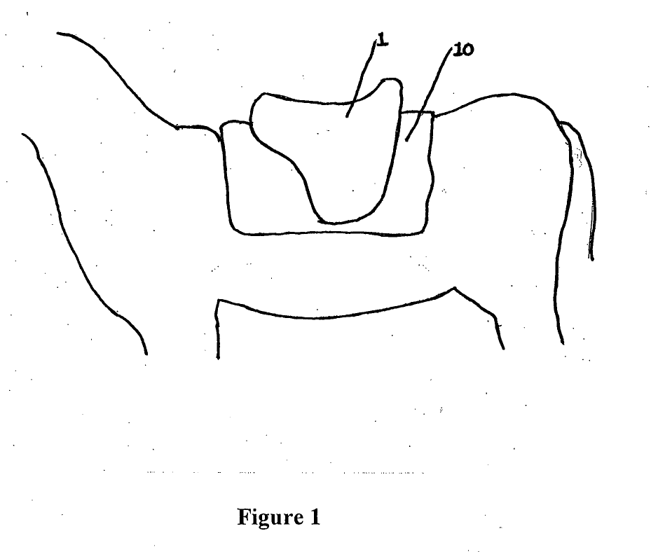

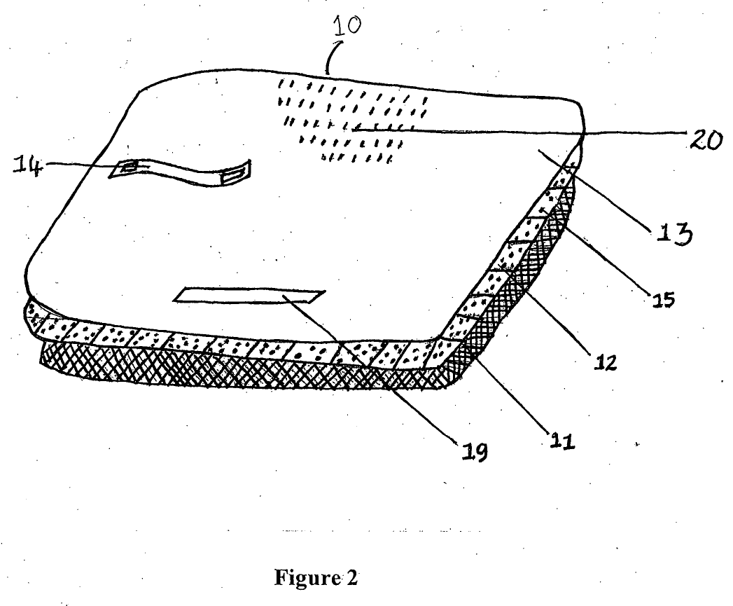

FIG. 1 illustrates a disposable saddle pad 10 between a saddle 1 and a horse's back. As shown in FIG. 2, the disposable saddle pad 10 has a first layer 11 closest to the horse's skin, which is made of a gauze-like material. This first layer 11 may wick the moisture away from the horse's skin to a middle layer 12 of the disposable saddle pad 10.

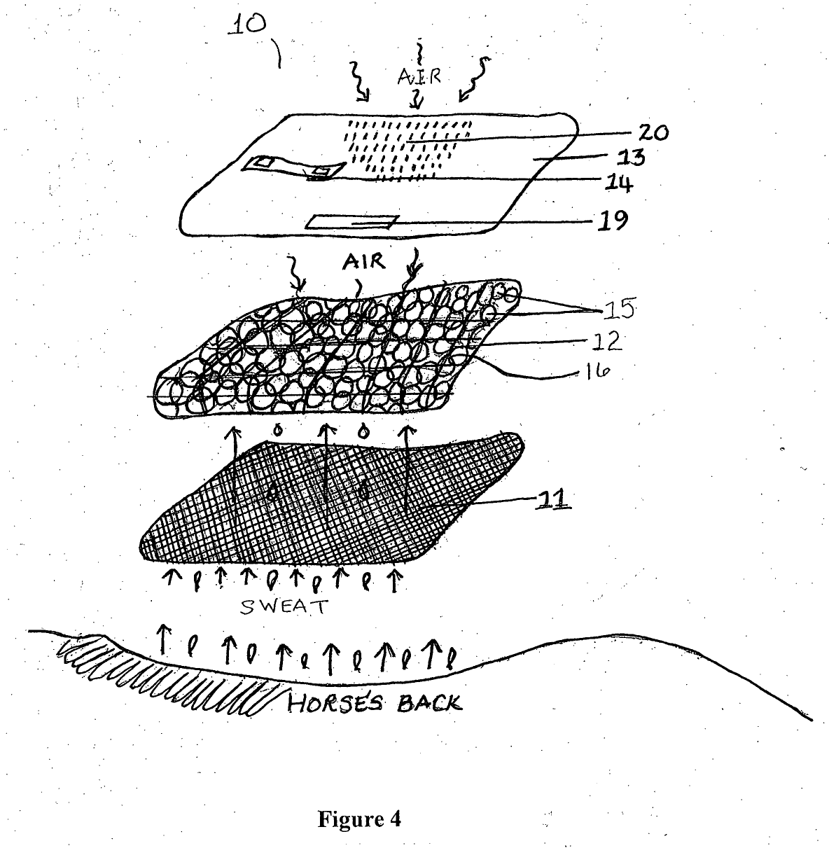

The middle layer 12 is an absorbent layer that may include batting, which may be made of foam and/or cotton wadding and small granules. The small granules may be a crystalline material, a gel material, etc. For example, super absorbent polymers may be used. When exposed to moisture, the granules may absorb the moisture and swell becoming jelly-like to the touch. The middle layer 12 that has absorbed moisture and has swelled is illustrated in FIG. 4.

Not only does the middle layer 12 absorb sweat, but it also may aid in the horse's cooling process. As the gel granules 15 swell from absorbing the sweat, the swelling causes slits or perforations at the surface layer/layers 16 and 17 to open up to allow more air to flow through the batting and provide more air close to the surface of the horse. The slits or perforations are illustrated in FIG. 4. As a result the moisture is wicked from the surface of the horse and the horse's skin is ventilated and cooled. Furthermore, the more the horse sweats, the more the granules will swell and more air will enter the pad by opening more slits or perforations, and thereby cool the horse.

The disposable saddle pad 10 should provide cushioning or pressure absorbing abilities. This is desirable to the rider because, if a horse is “back sore” due to uneven pressure points caused by the weight of the rider, or the saddle pad bunching up, the horse will not perform as well as it could, and in some extreme cases can become dangerous due to the pain it is experiencing.

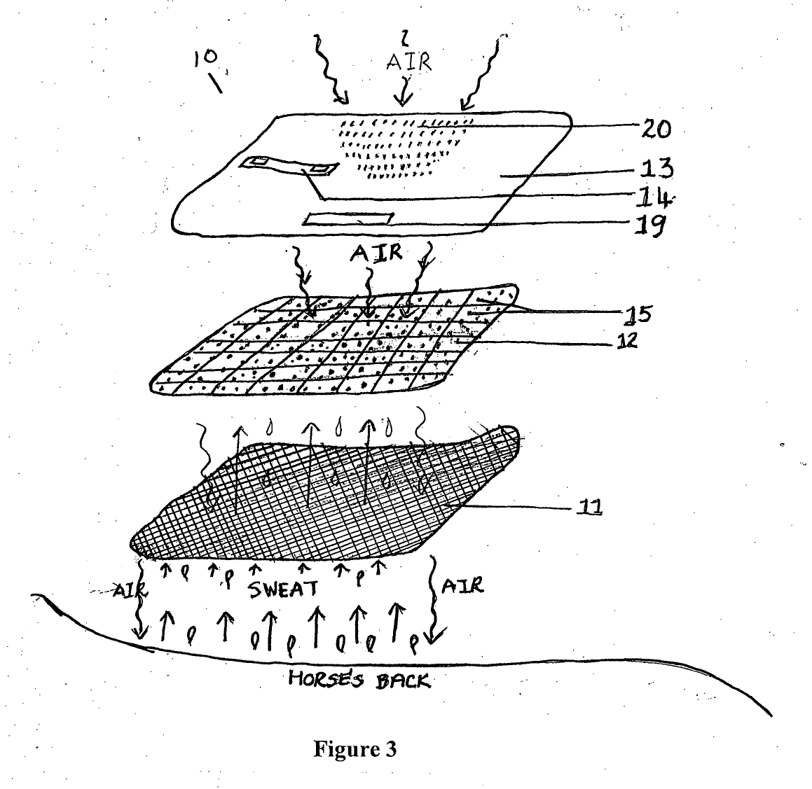

The saddle pad 10 provides more cushioning than a traditional saddle pad as the ride progresses. Referring to FIG. 3, the moisture from the horse's sweat goes through the first layer 11 and then becomes absorbed by the granules 15 in the middle layer 12, which will swell and become jelly-like, see FIG. 4. This causes the pad 10 to thicken and give it an even more cushiony consistency, as shown in FIG. 4. Thus as the ride progresses the disposable saddle pad 10 provides a cushiony consistency that reduces any pressure points caused by the weight of the rider and the saddle on the horse's back.

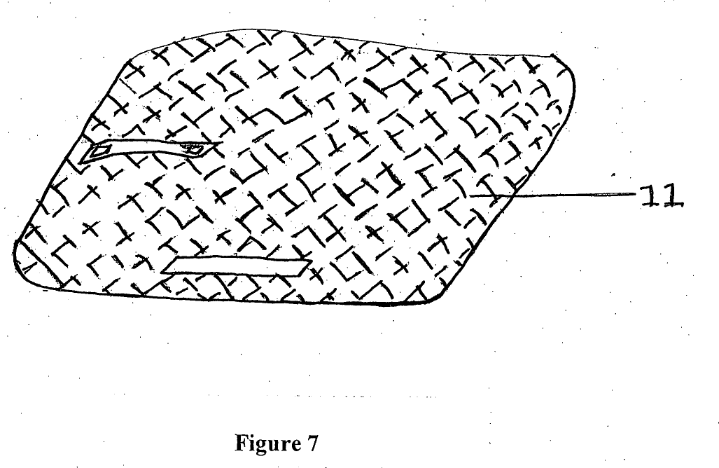

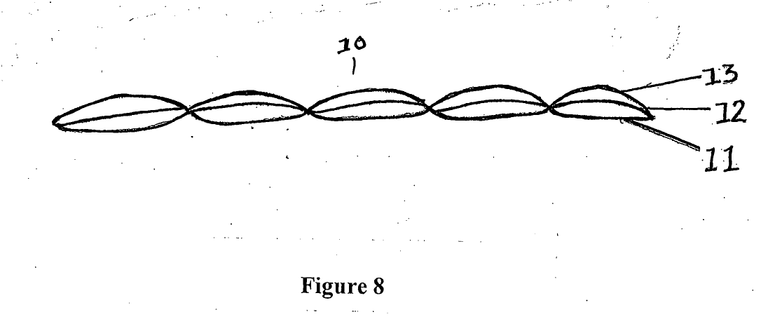

The next layer is a top layer 13 which may lay closest to the saddle and be seen when the disposable saddle pad is on the horse. This layer may act as a barrier and may inhibit the pad from absorbing moisture from the atmosphere if, for example, the horse is being ridden in the rain. The top layer 13 may contain perforations 20 under the saddle area to aid air circulation within the pad. The top layer 13 may be constructed to closely resemble a traditional cotton traditional saddle pad in appearance. For instance, the disposable saddle pad 10 may include a “quilting” texture as shown in FIG. 7. This quilting functions to fuse all the layers together and keep them in place as shown in FIG. 8.

Referring back to FIG. 2, lateral friction on the horse's back may occur when the rider, saddle and disposable saddle pad move against the motion of the horse. Accordingly, the first layer 11 may be made of a gauze-like material, which would allow it to freely move with the flow of the horse's motion and absorb the lateral friction of movement from the horse. This prevents the disposable saddle pad 10 from rubbing against the horse's movement, because, the first layer 11 would move with the horse's surface movement. This is an advantage over traditional saddle pads, which have a tendency to slip and move under the saddle, and/or bunch up due to the horse's movement.

To reduce slipping out from under the saddle, the disposable saddle pad may be held in place by strips 14 affixed to the front of the disposable saddle pad near the horse's withers and pulled around the stirrup billets and secured with hook and loop end tabs or other fastening mechanisms. Fixed strips 19 can also be located where the disposable saddle pad sits towards the stomach end of the horse where the rider feeds the girth through. The disposable saddle pad fastens to the saddle by using a non-stick fastener strip to go around the saddle billets and fasten back on itself.

FIGS. 3 & 4 also illustrate the direction in which sweat is wicked into the middle layer 12 and the direction in which air flows to cool the horse. As shown in FIG. 3 sweat is wicked upward by the first layer 11 towards the middle layer 12. The middle layer 12 swells as it absorbs the sweat from the horse. While the sweat from the horse is being wicked up into the middle layer 12, air flows downward through the perforations 20 of the top layer 13 and the slits or perforations 16 and 17 formed in the middle layer 12 to cool the horse's skin, as shown in FIG. 4. As discussed above, the horse's exertion and sweating may actually improve the cushioning ability of the pad. In contrast, when a traditional saddle pad gets wet with sweat, it usually looses its cushioning as all the layers stick together and the batting becomes flat under the saddle.

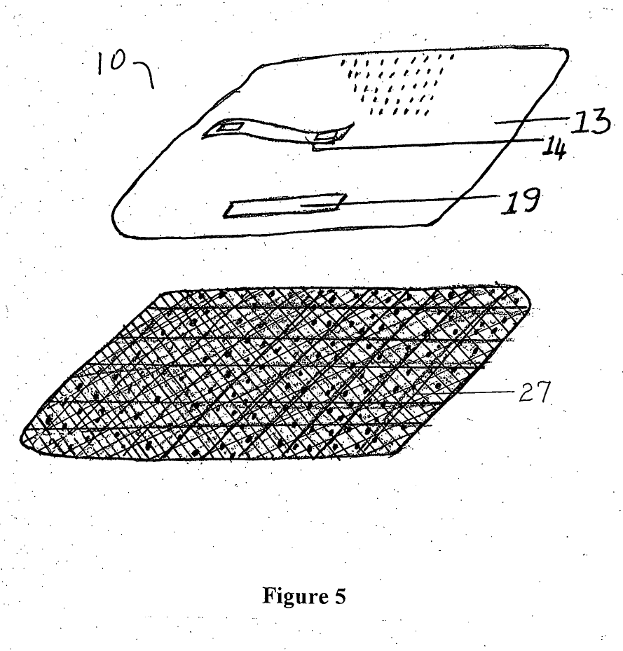

FIG. 5 illustrates an exemplary disposable saddle pad 10 that incorporates the wicking and moisture absorbing properties into a single layer. The disposable saddle pad 10 of this embodiment includes a wicking and moisture absorbing layer 27 and a top layer 13. The wicking and moisture absorbing layer 17 may be constructed of a gauze-like material and moisture absorbing granules 15. The gauze-like material may be cotton. The moisture absorbing granules may be a crystalline material, gel material, etc.

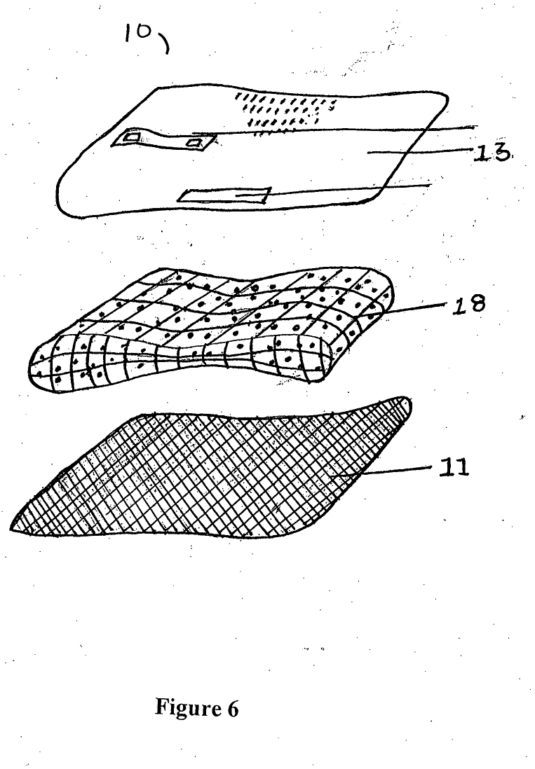

FIG. 6 illustrates another exemplary disposable saddle pad 10 where the thickness of the middle layer is unevenly distributed. The first layer 11 includes a gauze-like material to wick sweat away from the horse's skin. The middle layer 18 includes batting material with granules 15 that absorb the sweat wicked away by the first layer 11. In the areas where the saddle contacts the horse's back, the middle layer 18 has more material than the areas where the saddle is not in contact with the horse's back. The pressure absorbing characteristics of the saddle pad 10 can be customized by varying the thickness of the middle layer 18 according to the riders' preference.

FIGS. 7-8 illustrate an embodiment of a disposable saddle pad that includes a quilted pattern. As shown in FIG. 8 the quilted pattern also bonds the first layer 11, middle layer 12 and top layer 13 together. The quilted pattern gives the appearance of a traditional saddle pad. The disposable saddle pad 10 can be made in any color and can be customized with a barn name or logo printed on it. This disposable saddle pad 10 can be constructed in different sizes and shapes to accommodate different equestrian disciplines and horse sizes. It can also be constructed in different saddle pad thicknesses as well.

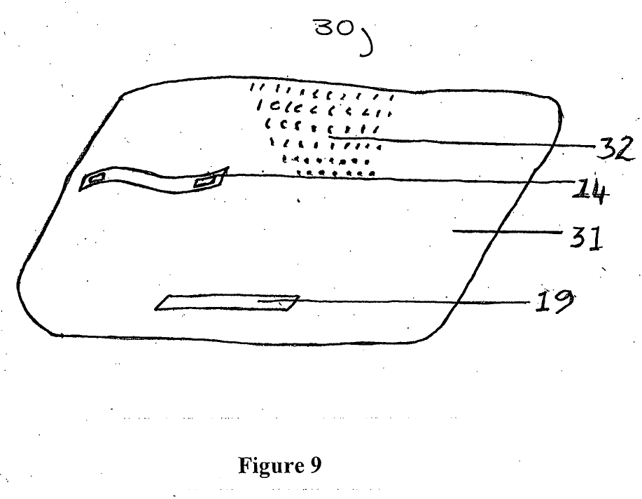

FIG. 9 illustrates an exemplary disposable saddle pad 30 that is constructed of a barrier material 31 that does not absorb moisture from the atmosphere. This pad 30 contains tiny perforations 32 under the saddle area to aid air circulation to the horse.

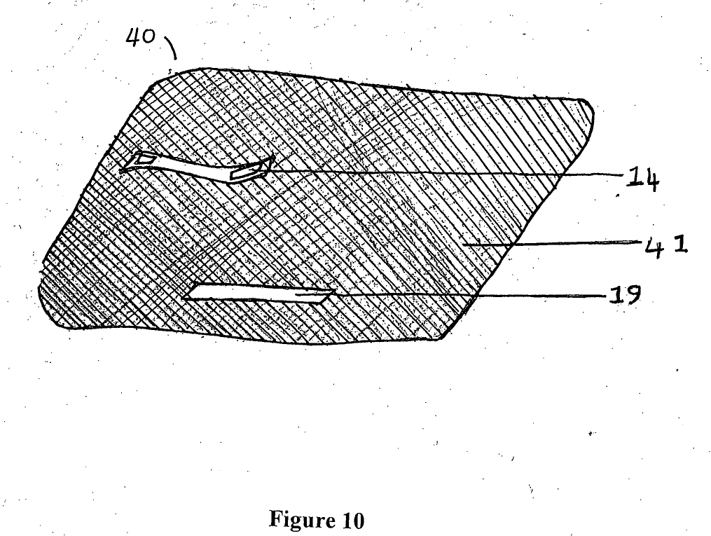

FIG. 10 includes an exemplary disposable saddle pad 40 that is constructed of gauze material 41. This gauze material 41 wicks sweat away from the horse's skin and allows air to flow through and cool the horse.

While various embodiments of the invention have been described, it is evident that many alternatives, modifications and variations will be apparent to those skilled in the art. Accordingly, exemplary embodiments of the invention, set forth above, tend to be illustrative, and not limiting. Thus it is intended that the many alternative modifications and variations be covered by the claims.

What is claimed is:

1. A disposable saddle pad comprising:
a wicking layer.

2. The disposable saddle pad of claim 1, wherein said wicking layer is made of a cotton gauze material.

3. The disposable saddle pad of claim 1, further comprising a barrier layer.

4. The disposable saddle pad of claim 3, wherein said barrier layer includes multiple perforations on the surface thereof.

5. The disposable saddle pad of claim 1, further comprising an absorbing layer having a thickness.

6. The disposable saddle pad of claim 5, wherein the absorbing layer comprises a batting material made of foam and/or cotton.

7. The disposable saddle pad of claim 6, further comprising granules interposed within the absorbing layer.

8. The disposable saddle pad of claim 7, wherein said granules comprise a gel material that increases in size when moisture is absorbed by said granules.

9. The disposable saddle pad of claim 5, wherein said absorbing layer is interposed between the wicking layer and the barrier layer such that the wicking layer is a bottom layer and the barrier layer is a top layer.

10. The disposable saddle pad of claim 9, wherein the barrier layer, absorbing layer and wicking layer are joined together at joining spots formed intermittently on said disposable saddle pad.

11. The disposable saddle pad of claim 9 wherein the thickness of absorbing layer is unevenly distributed.

12. A disposable saddle pad comprising:
a barrier layer.

13. The disposable saddle pad of claim 12, wherein said barrier layer includes multiple perforations on the surface thereof.

14. The disposable saddle pad of claim 12, further comprising an absorbing layer.

15. The disposable saddle pad of claim 14, wherein the absorbing layer comprises a batting material made of foam and/or cotton.

16. The disposable saddle pad of claim 15, further comprising granules interposed within the absorbing layer.

17. The disposable saddle pad of claim 16, wherein said granules comprise a gel material that increases in size when moisture is absorbed by said granules.

18. The disposable saddle pad of claim 14, wherein the barrier layer and the absorbing layer are joined together such that the barrier layer is on top.
